(19) United States
(12) Patent Application Publication
(10) Pub. No.: US 2010/0255808 A1
(43) Pub. Date: Oct. 7, 2010

(54) METHOD AND APPARATUS FOR IMPLEMENTING EMERGENCY CALLS

(76) Inventors: Wei Guo, Shenzhen (CN); Xiaoqin Duan, Shenzhen (CN); Jian Zhang, Shenzhen (CN); Qingyu Li, Shenzhen (CN); Xiaobo Wu, Shenzhen (CN)

Correspondence Address: Huawei Technologies Co., Ltd./Finnegan, 901 New York Avenue, NW, Washington, DC, 20001, US

(21) Appl. No.: 12/818,966

(22) Filed: Jun. 18, 2010

Related U.S. Application Data
(63) Continuation of application No. PCT/CN2008/073577, filed on Dec. 18, 2008.

(30) Foreign Application Priority Data
Dec. 18, 2007 (CN) 200710301851.X

(51) Int. Cl. H04W 4/22

(52) U.S. Cl. 455/404.1

(57) ABSTRACT

An emergency call method includes the following blocks: a User Equipment (UE) sends an emergency attach request that establishes an emergency indication to a System Architecture Evolution (SAE) network; the SAE network selects an emergency call service entity for the UE after receiving the emergency indication; the UE sends an emergency call request to the emergency call service entity after getting attached to the SAE network emergently; and the emergency call service entity establishes an emergency voice bearer, whereupon the UE makes an emergency call according to the established emergency voice bearer. Through the method for simulating a Circuit Switched (CS) emergency call by means of an emergency call service entity in the SAE network, the emergency call service can be implemented in the SAE or Long Term Evolution (LTE) packet network.

### CROSS-REFERENCE TO RELATED APPLICATIONS

This application is a continuation of International Application No. PCT/CN2008/073577, filed on Dec. 18 2008, which claims priority to Chinese Patent Application No. 200710301851.X, filed on Dec. 18, 2007, both of which are hereby incorporated by reference in their entireties.

### FIELD OF THE INVENTION

The present invention relates to mobile communications technologies, and in particular, to a method and an apparatus for implementing emergency calls.

### BACKGROUND OF THE INVENTION

The Universal Mobile Telecommunications System (UMTS) is a 3^{rd} Generation (3G) mobile telecommunications system based on a Wideband Code Division Multiple Access (WCDMA) air interface technology. The UMTS is also known as a WCDMA system. A UMTS system includes a Radio Access Network (RAN) and a Core Network (CN). The RAN deals with radio-related functions. The CN is designed for processing all voice calls and data connections in the UMTS system and is responsible for switching and routing to external networks.

FIG. 1 shows logical architecture of a UMTS system in the prior art. The main parts of a UMTS system are described as follows:

A Gateway General Packet Radio Service Support Node (GGSN) serves as a basic functional network element to encapsulate packets and routing packets between external data networks. A Serving GPRS Support Node (SGSN) serves as a basic integral network element to forward input/output Internet Protocol (IP) packets to Mobile Stations (MSs) in the service area of this SGSN. A Radio Access Network (RAN) is composed of a Radio Network Controller (RNC) and a Node Base station (NodeB).

Currently, a Long Term Evolution (LTE) or System Architecture Evolution (SAE) technology is provided. The LTE aims to provide a cost-effective network which reduces delay, increases the user data rate, and improves the system capacity and coverage. The LTE/SAE provides Packet Switched (PS) services over IP. FIG. 2 shows architecture of an LTE/SAE network in the prior art.

The architecture of an SAE network and its functions are described below. In an evolved packet core network:

A Mobility Management Entity (MME) is designed to store mobility management contexts of a User Equipment (UE), for example, a user ID, a mobility management state, and location data, process Non Access Stratum (NAS) signaling, and is responsible for security of the NAS signaling.

An SAE Gateway (GW) includes two parts: a Serving Gateway (SGW or S-GW) and a PDN Gateway (PDN GW or P-GW), where PDN is an acronym of Packet Data Network. The SGW and the PDN GW are two logical entities, which may exist on the same physical entity or different physical entities.

The SGW stores the user-plane context of the UE, for example, IP address and route data of the UE, and performs lawful interception and routing of packet data.

The MME is connected to an Evolved UMTS Terrestrial Radio Access Network (EUTRAN) on the control plane through an S1-MME interface, and the SGW is connected to the EUTRAN on the user plane through an S1-U interface. Meanwhile, the MME is connected to the 2G/3G SGSN through an S3 interface, and the SGW is connected to the 2G/3G SGSN through an S4 interface. The MME serves as a mobility control-plane anchor of the UE between the 3G network and the SAE network, and the SGW serves as a mobility user-plane anchor of the UE between the 3G network and the SAE network.

The PDN GW serves as a user-plane anchor which enables the UE to access the PDN. The PDN GW communicates with an external PDN through an SGi reference point, and provides the functions of routing and forwarding packets, the function of enhancing policy and charging control, and the function of filtering packets based on each user.

With the evolution from the existing network to the SAE/LTE network, the Circuit Switched (CS) services in the existing network need to be transformed to PS services. For example, the CS voice call service needs to be transformed to a PS Voice over IP (VoIP) service. But, in the current SAE/LTE network, no solution is available for implementing an emergency call service.

### SUMMARY OF THE INVENTION

The embodiments of the present invention provide a method and an apparatus for implementing emergency calls.

An emergency call method provided in an embodiment of the present invention includes:
sending, by a UE, an emergency attach request to an SAE network, where the emergency attach request establishes an emergency indication;
selecting, by the SAE network, an emergency call service entity for the UE after receiving the emergency indication;
sending, by the UE, an emergency call request to the emergency call service entity after getting attached to the SAE network emergently; and
establishing, by the emergency call service entity, an emergency voice bearer, whereupon the UE makes an emergency call according to the established emergency voice bearer.

An emergency call release method provided in an embodiment of the present invention includes:
receiving, by an emergency call service entity, a relevant release message sent by a UE or an emergency call center; and
releasing, by the emergency call service entity, relevant emergency voice bearer resources according to the relevant release message.

An emergency attach method provided in an embodiment of the present invention includes:
sending, by a UE, a NAS message to an SAE network after detecting that a user is originating an emergency call, where the NAS message establishes an emergency indication and a unique ID of the user; and
selecting, by the SAE network, a local PDN GW for the UE according to the NAS message after receiving the NAS message, whereupon the PDN GW allocates a corresponding IP address to the UE so that the UE gets attached to the SAE network.

An emergency call service entity provided in an embodiment of the present invention includes:
an emergency attach processing module, configured to receive an emergency attach request from a UE;
a bearer establishment data obtaining module, configured to obtain bearer establishment data required for establishing an emergency voice bearer for the UE after the UE originates an emergency call;
a bearer data delivering module, configured to deliver the bearer establishment data to a Media Gateway (MGW) and a Policy and Charging Rules Function (PCRF) separately;
a bearer establishment instructing module, configured to instruct the MGW and the PCRF to create an emergency voice bearer on the emergency call service entity side and an emergency voice bearer on the SAE network side; and
a bearer association controlling module, configured to control the MGW to associate the emergency voice bearer on the emergency call service entity side with the emergency voice bearer on the SAE network side after the bearer on the emergency call service entity side and the bearer on the PCRF side are established, whereupon the UE makes an emergency call according to the emergency voice bearer on the emergency call service entity side and the associated emergency voice bearer on the SAE network side.

The technical solution in the embodiments of the present invention brings the following benefits: Through the emergency call method and emergency call apparatus provided herein, the CS emergency calls can be simulated in an SAE/LTE network by means of an emergency call service entity.

### BRIEF DESCRIPTION OF THE DRAWINGS

FIG. 1 shows logical architecture of a UMTS system in the prior art;

FIG. 2 shows architecture of an LTE/SAE network in the prior art;

FIG. 3 is a flowchart of a method for implementing an emergency call in an embodiment of the present invention;

FIG. 4 is a flowchart of a method for implementing an emergency call in Embodiment 1 of the present invention;

FIG. 5 shows eMSC network architecture A in an embodiment of the present invention;

FIG. 6 shows eMSC network architecture B in an embodiment of the present invention;

FIG. 7 is a flowchart of a method for simulating a CS domain to implement an emergency call in a PS domain in Embodiment 2 of the present invention;

FIG. 8 is a flowchart of access initiated by a UE in the case of non-3GPP access in an embodiment of the present invention;

FIG. 9 is a flowchart of a method for simulating a CS domain to implement an emergency call in a PS domain in Embodiment 3 of the present invention;

FIG. 10 is a flowchart of a method for simulating a CS domain to implement an emergency call in a PS domain in Embodiment 3 of the present invention;

FIG. 11 is a flowchart of a method for simulating a CS domain to implement an emergency call in a PS domain in Embodiment 4 of the present invention;

FIG. 12 is a flowchart of a method for simulating a CS domain to implement an emergency call in a PS domain in Embodiment 5 of the present invention;

FIG. 13 is a flowchart of a method for simulating a CS domain to implement an emergency call in a PS domain in Embodiment 6 of the present invention;

FIG. 14 is a flowchart of a method for simulating a CS domain to implement an emergency call in a PS domain in Embodiment 7 of the present invention; and

FIG. 15 shows a structure of an eMSC in an embodiment of the present invention.

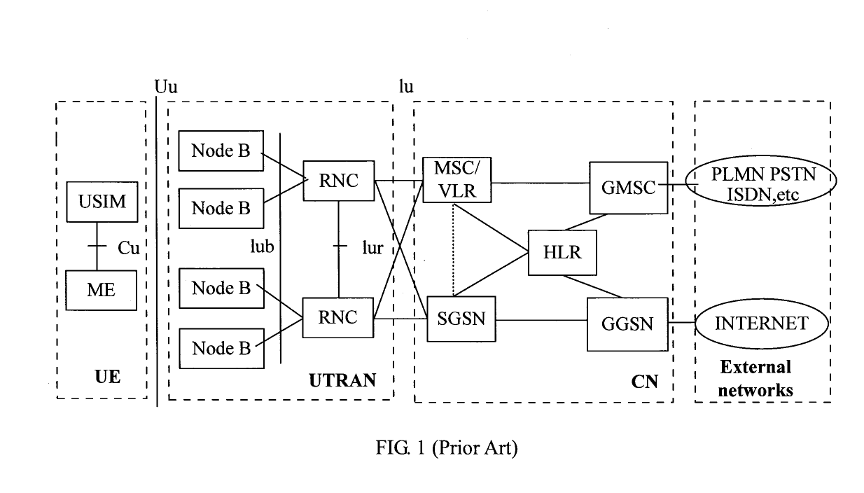

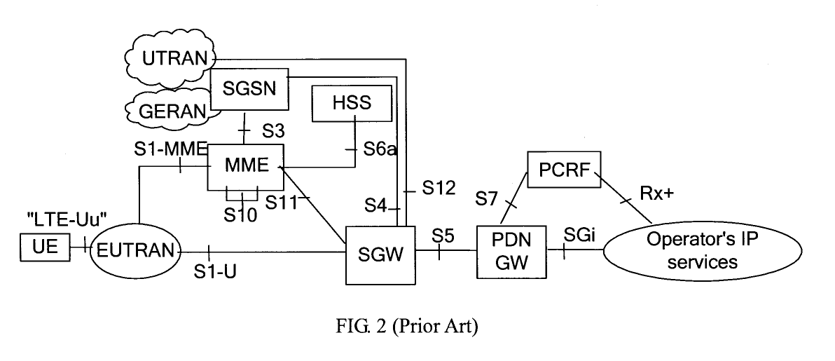

### DETAILED DESCRIPTION OF THE EMBODIMENTS

In the embodiments of the present invention, an emergency call service entity is used to simulate CS emergency calls in the PS domain so that an operator can protect the existing investment and continue to provide traditional CS services as far as possible. The emergency call service entity is an evolved Mobile Switching Center (eMSC) or a Proxy-Call Session Control Function (P-CSCF) in an IP Multimedia Subsystem (IMS). Through the emergency call service entity, the emergency voice bearer on an evolved Media Gateway (eMGW) side is associated with the emergency voice bearer on the SAE network side to implement emergency calls of the UE. In the process of implementing the embodiments of the present invention, the status quo is considered, for example, emergency services are not restricted by subscription and are high-priority services, a roaming user can complete emergency services on a visited network, and the deployment of an IMS network is pending. The embodiments of the present invention are optimized according to the status quo.

In the following embodiments, the emergency call service entity is assumed to be an eMSC. However, in other network architecture, the emergency call service entity may be other devices. For example, in an IMS network deployed by the operator, the emergency call service entity may be a P-CSCF in the IMS network.

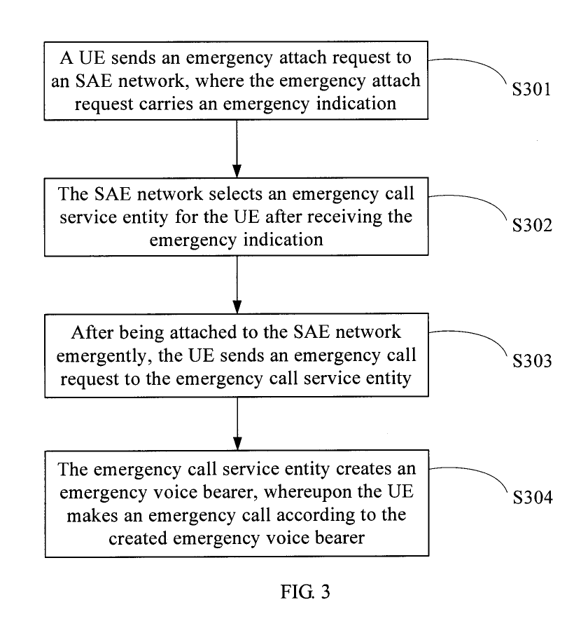

As shown in FIG. 3, an emergency call method provided in an embodiment of the present invention includes the following blocks.

Block 301: A UE sends an emergency attach request to an SAE network, where the emergency attach request establishes an emergency indication.

Block 302: After receiving the emergency indication, the SAE network selects an emergency call service entity for the UE.

Block 303: After being attached to the SAE network emergently, the UE sends an emergency call request to the emergency call service entity.

Block 304: The emergency call service entity establishes an emergency voice bearer, and the UE makes an emergency call according to the established emergency voice bearer.

The technical solution in this embodiment brings the following benefits: Through the emergency call method and emergency call apparatus provided herein, the CS emergency calls can be simulated in an SAE/LTE network by means of an emergency call service entity

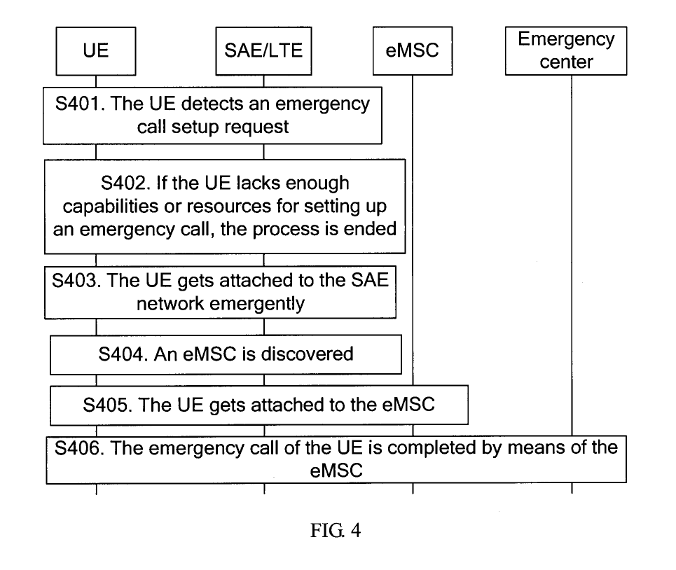

FIG. 4 is a flowchart of a method for implementing an emergency call in Embodiment 1 of the present invention. This flowchart is an overall flowchart of the embodiments of the present invention. The details about this flowchart are provided in the subsequent embodiments. The method in this embodiment includes the following blocks.

Block S401: The UE detects an emergency call setup request.

Block S402: If the UE lacks enough capabilities or resources for setting up an emergency call, this process is ended.

Block S403: The UE gets attached to the SAE network emergently, and sets up a CS signaling bearer through this attach process.

Block S404: An eMSC is discovered.

Block S405: The UE gets attached to the eMSC.

Block S406: The emergency call of the UE is completed by means of the eMSC.

In Blocks S401-S403, the UE gets attached to the SAE/LTE network emergently. In the foregoing embodiment, the emergency attach to the SAE/LTE network is a basis for the UE to get attached to the eMSC. After getting attached to the SAE/LTE network, the UE can obtain the corresponding IP address for establishing a connection with the eMSC and preparing for the subsequent emergency call. The process of the emergency attach to the SAE/LTE network provided in the foregoing embodiment is not only applicable to the eMSC, but also applicable to emergency calls to the IMS. The location and functions of the eMSC in the emergency call are equivalent to those of a P-CSCF in the IMS emergency call. The UE may get attached to an SAE network emergently in the following embodiments to implement an IMS emergency call, which is also covered in the scope of the present invention.

In the eMSC solution under the present invention, the process of setting up an emergency call and the process of establishing an SAE emergency bearer are related to the architecture of the SAE network. For example, the architecture of the SAE network involves these factors: an interface that is similar to Gs and exists between the eMSC and the SAE network may be introduced in the SAE network system or not; this interface may be capable of transmitting upper-layer signaling for calls or not; and how the call signaling and the media plane can be set up securely without such an interface. The embodiments of the present invention provided two network architectures of the eMSC solution, and provide details about simulating the CS domain to set up an emergency call and establish an SAE emergency bearer in the PS domain in different architectures. The two eMSC network architectures provided herein are architecture A and architecture B.

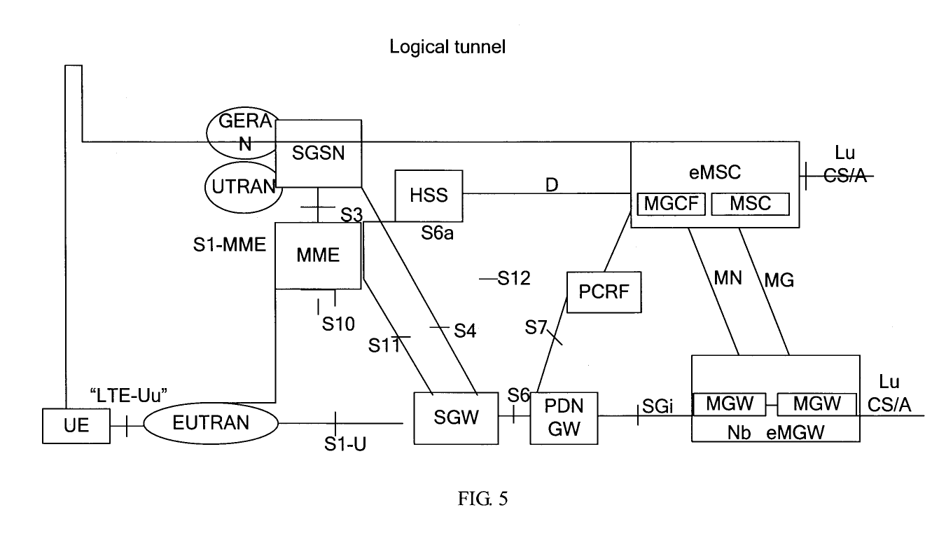

FIG. 5 shows eMSC network architecture A in an embodiment of the present invention. In architecture A, the eMSC provides some functions of an MSC and a Media Gateway Control Function (MGCF), and provides the functions of an Application Server (AS) in the PS domain. Through an Rx+ interface between the eMSC and the PCRF, the eMSC controls the bearer establishment in the PS domain. Through a logical tunnel between the eMSC and the UE, the CS signaling transmission is simulated. An eMGW entity is introduced as a media-plane conversion gateway (namely, conversion between PS VoIP data and the CS VoIP data). This entity provides the functions of an IM-MGW in the IMS domain and an MGW in the CS domain.

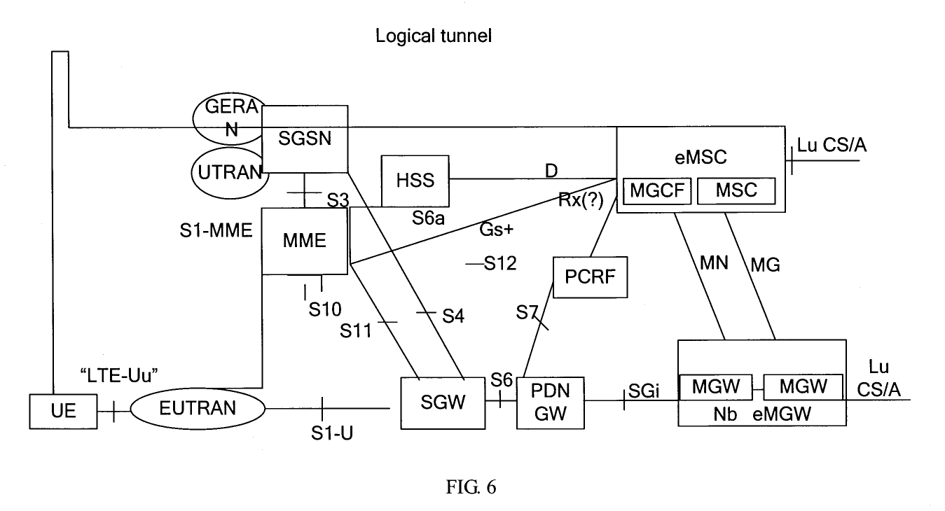

FIG. 6 shows eMSC network architecture B in an embodiment of the present invention. Architecture B is similar to architecture A, but an interface similar to Gs+ and existent between the MME and the eMSC is introduced into architecture B. This interface is designed to transmit call message parameters.

The following provides details about the emergency call method under the present invention based on architecture A and architecture B.

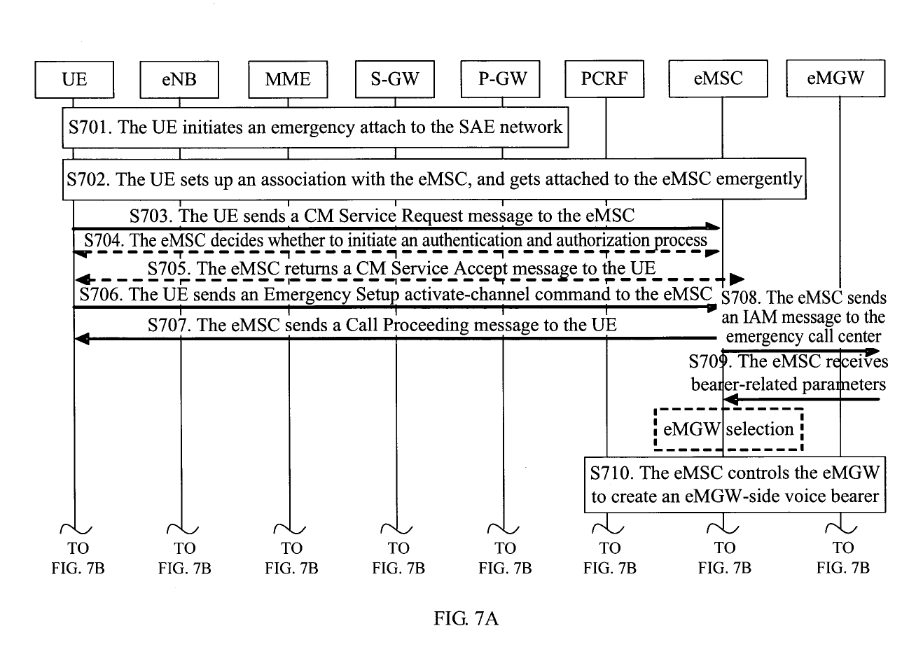

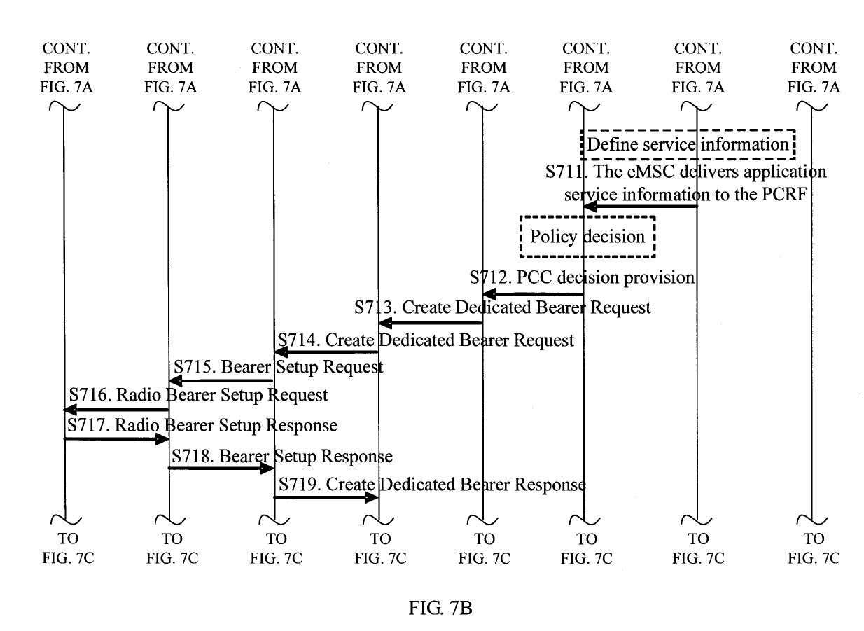

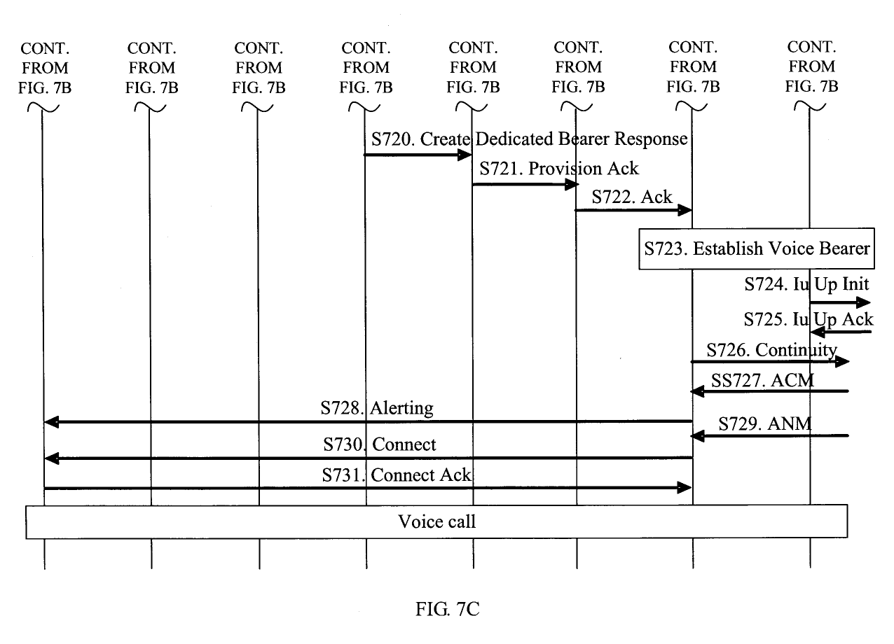

FIG. 7 is a flowchart of a method for simulating the CS domain to implement an emergency call in the PS domain in Embodiment 2 of the present invention. This embodiment is based on architecture A, which involves no interface similar to the Gs interface. In this embodiment, the voice media plane data of the UE is transmitted over an SAE/LTE dedicated bearer or a default bearer. Before the UE gets attached to the eMSC, a local PDN GW needs to allocate an IP address to the UE for emergency calls.

Block S701: The UE sends an Emergency Attach Request to the SAE network. The SAE network selects a local PDN GW for the UE, obtains an IP address which is allocated by the local PDN GW to the UE for emergency calls, and establishes a default bearer or a dedicated bearer for relevant signaling for simulating CS domain registration and calls. The bearer establishment request establishes an emergency indication. In this Block, a precondition for the UE to initiate an emergency attach is: The UE can perceive that the user is originating an emergency call. In this embodiment, a specific key may be defined in the UE to identify the emergency call, or the UE identifies the digits dialed by the user as an emergency number. For example, once the user dials 110, the UE identifies 110 as an emergency number automatically, and sends an Emergency Attach Request to the SAE network automatically.

In this embodiment, the UE needs to get attached to the SAE network emergently before the user gets attached to the SAE network.

For example, taking the 3^{rd} Generation Partnership Project (3GPP) access as an example, the attach process may include the following blocks:

A. The UE sends an Emergency Attach Request message to the SAE network. The Emergency Attach Request establishes an emergency indication and a unique ID of the user.

(1) If the user has a Universal Subscriber Identity Model (USIM) card for the purpose of emergency call services, the UE needs to initiate an emergency attach process regardless of whether the user gets attached to the network or not (this attach refers to a normal attach of the UE to the network, which is different from the emergency attach). The Emergency Attach Request message establishes the user ID. If the user IMSI serves as the UE ID, unlike a normal attach request, the Emergency Attach Request message establishes an emergency indication so that the network can identify the emergency attach. The message may further carry an emergency Access Point Name (APN) as a reference for subsequent PDN GW selection. In this process, the network decides whether to perform the authentication and authorization process. If the UE has been attached to the network, a Tracking Area Update (TAU) process or a service request process may be performed to trigger a search process of a local PDN GW. The TAU Request message and the service request message carry an emergency indication and may carry an emergency APN additionally.

(2) If the user has no USIM card, the UE uses an IMEI as its ID data in the Emergency Attach Request message. The emergency indication tells the network that the attach is an emergency attach, and may also carry an emergency APN. The network does not need to perform the authentication and authorization process.

B. Due to the policy of implementing emergency calls locally, the network needs to find a local PDN GW in the attach process, and the local PDN GW allocates an IP address to the UE for emergency calls. The policies of selecting a PDN GW are as follows.

(1) If the attach request message of the UE establishes an emergency APN data (which includes a network ID and an operator ID), the MME needs to judge whether the emergency APN belongs to the local network. If the emergency APN belongs to the local network, the MME selects a local PDN GW according to the emergency APN data; otherwise, the MME selects a PDN GW according to the default emergency APN data configured by the MME.

(2) If the attach request message of the UE establishes an emergency APN data (which includes only a network ID), the MME selects a local PDN GW according to the default emergency APN data configured by the MME.

(3) If the attach request message of the UE establishes no emergency APN data, after determining that the request message of the UE establishes an emergency indication and the UE uses an IMSI as its ID, the MME searches a Home Subscriber Server (HSS) for the subscription data of the user and judges whether the subscribed emergency APN of the user belongs to the local network. If the subscribed emergency APN of the user belongs to the local network, the MME uses the subscribed emergency APN of the user, or else uses the default emergency APN data configured by the MME to select a PDN GW.

(4) If the attach request message of the UE establishes no emergency APN data, the MME is unable to obtain the subscription data of the user from the HSS; or, if the user uses an IMEI as its ID and the attach request message establishes an emergency indication, the MME selects a PDN GW according to the default emergency APN configured by the MME.

The details about selecting a local PDN GW for the UE are: After receiving an attach request message, the MME decides to use the locally configured static PDN GW selection function, or use both the locally configured emergency APN data and the locally configured static PDN GW selection function to select a local PDN GW for the UE according to the emergency indication carried in the message.

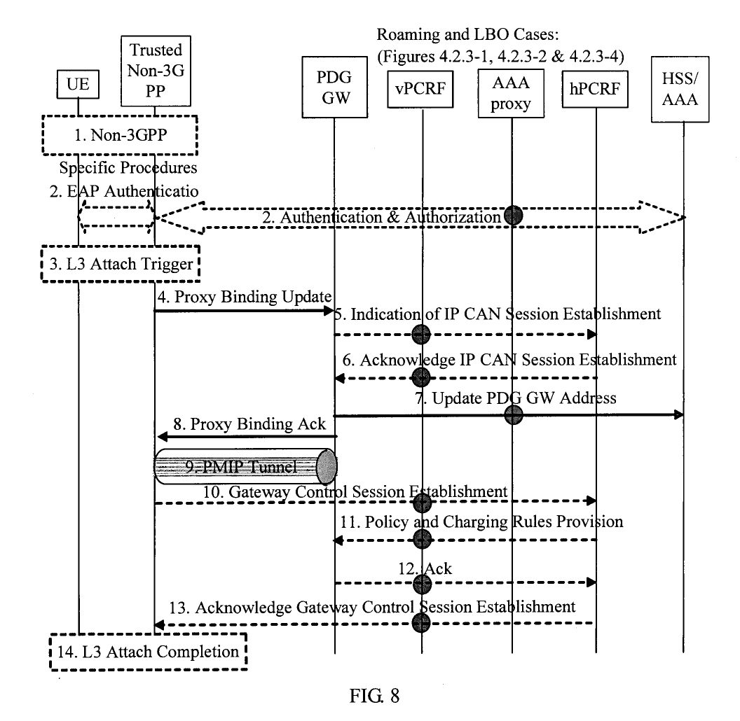

The foregoing embodiment takes the 3GPP access as an example. In other embodiments of the present invention, the UE may access a local PDN in non-3GPP access mode. That is, the UE obtains an IP address for emergency calls. FIG. 8 shows an access process initiated by the UE in the case of non-3GPP access in an embodiment of the present invention. In the following blocks, the attach request message sent by the UE may carry an emergency indication:

A. In the Extensible Authentication Protocol (EAP) authentication process in block 2, a trusted non-3GPP IP access network sends the emergency indication of the UE to an Authentication, Authorization, and Accounting (AAA) proxy and the subsequent local PDN GW. In block 5, the Indication of IP CAN Session Establishment message of the PDG GW also establishes the emergency indication.

B. In the L3 Attach Trigger process in block 3, the attach request message of the UE establishes an emergency indication, and the trusted non-3GPP IP access network transmits the emergency indication to the PDN GW in block 4, and therefore, the PDN GW indicates that the session is an emergency session in the session setup in block 5.

In the foregoing embodiment, the attach request message establishes an emergency indication so that the MME can select a local PDN GW. However, the embodiments of the present invention are not limited to the attach request message, and any other NAS message may also carry the emergency indication to the MME. If the UE (with a USIM card) has been attached to the network normally but not emergently (in this case, the PDN GW is not necessarily local), the UE may initiate another service request process or TAU process to find the local PDN GW and obtain an IP address allocated by the PDN GW for emergency calls. The request messages sent in the two processes above need to carry an emergency indication.

Block S702: The UE associates with the eMSC, gets attached to the eMSC emergently, and sets up an IP tunnel to the eMSC. If the UE has a USIM card, the UE uses the IMSI as its ID; if the UE lacks a USIM card, the UE uses the IMEI as its ID and no authentication process is required. The attach request message may carry an emergency indication.

The eMSC discovery mechanism in the foregoing process is as follows:

A. Data about the request for the eMSC address is carried in an SAE emergency attach message or carried in a PCO option in the process of initiating bearer establishment. By resolving parameters in the PCO option, the PDN GW or the MME searches for a local eMSC address (for example, the eMSC address is configured, or the PDN GW obtains the address through a Dynamic Host Configuration Protocol (DHCP) query mechanism).

B. In the HSS, the eMSC address data is configured or stored for the user, and the HSS provides the data for the MME. However, this method is applicable to the home network.

C. According to preset conditions such as location data, operator preference, network topology, or the mapping relation between the MME and the eMSC configured on the network side, the MME selects a local eMSC for the UE.

D. The network sends a broadcast message to the UE within its coverage. The broadcast message indicates whether the network supports CS-over-SAE/LTE and establishes the corresponding eMSC address.

Block S703: When the UE originates an emergency voice call, the UE sends a CM Service Request message to the eMSC. The message establishes CM Service type which indicates an emergency call.

Block S704: After receiving the CM Service Request message, the eMSC decides whether to initiate an authentication and authorization process. If no authentication and authorization process needs to be initiated, the eMSC proceeds to Block S705 and returns a CM Service Accept message to the UE. If an authentication and authorization process needs to be initiated, the eMSC proceeds to block S706 after the authentication and authorization process is completed successfully.

Block S706: After the authentication and authorization process is completed successfully, or after a CM Service Accept message is received, the UE sends an Emergency Setup activate-tunnel command to the eMSC. The command establishes the following bearer establishment data: the media-plane IP address and User Datagram Protocol (UDP) port number accepted by the UE, bearer capabilities, stream ID, and voice codec list supported by the user. The emergency category field indicates the service type of the emergency call. The UE may provide its location data in this message.

Block S707: After determining that the emergency call is acceptable, the eMSC sends a Call Proceeding message to the UE.

Block S708 and block S709: The eMSC sends an IAM message to the emergency call center located in a Public Switched Telephone Network (PSTN) or a CS domain, and receives the bearer-related parameters. Afterward, a process of selecting an eMGW is triggered. After block S709, the eMSC may send bearer data to the UE through an IP tunnel, and the UE triggers a process of establishing a dedicated bearer or modifying the default bearer. The bearer establishment request establishes an emergency indication.

Block S710: The eMSC controls the eMGW to establish an eMGW-side voice bearer. The subsequent operations may be:

Scenario A: If the default bearer established when the UE gets attached to the SAE network is used to transmit signaling and bear voice, block S723 occurs immediately after block S709.

Scenario B: If the default bearer established when the UE gets attached to the SAE is used to transmit signaling, and, after some data (such as QoS) of the bearer is modified, the bearer is used to bear voice, a process of modifying the bearer occurs after block S709, and then block S723 occurs.

Block S711: The eMSC defines the data about the Rx interface, and delivers application service data to the PCRF. The application service data includes: IP address of the UE, user ID, media type and format, voice codec format, and emergency indication. According to the emergency indication, the PCRF grants the highest QoS to the emergency call, and applies a stream-based free-of-charge rule. When resources are scarce, the emergency call can obtain resources with high priority or preemptively.

Blocks S712-721: An emergency bearer of the voice service is established in the mode of establishing a dedicated emergency bearer in the SAE network.

Block S722: The PCRF returns an Ack message to the eMSC.

Blocks S723-726: The eMSC controls the eMGW to modify the association of media streams, and establishes an inter-MSC media bearer.

Blocks S727-730: After receiving the ACM message, the eMSC returns an Alerting message to the UE. After receiving an ANM message, the eMSC sends a Connect message to the UE.

Block S731: The UE returns a Connect Ack message to the eMSC, and starts an emergency voice conversation.

The dedicated bearer establishment mentioned above is initiated by the eMSC through an Rx interface. Besides, after receiving the Call Proceeding message, the UE may initiate dedicated bearer establishment first, and then the eMSC modifies the dedicated bearer through the Rx interface.

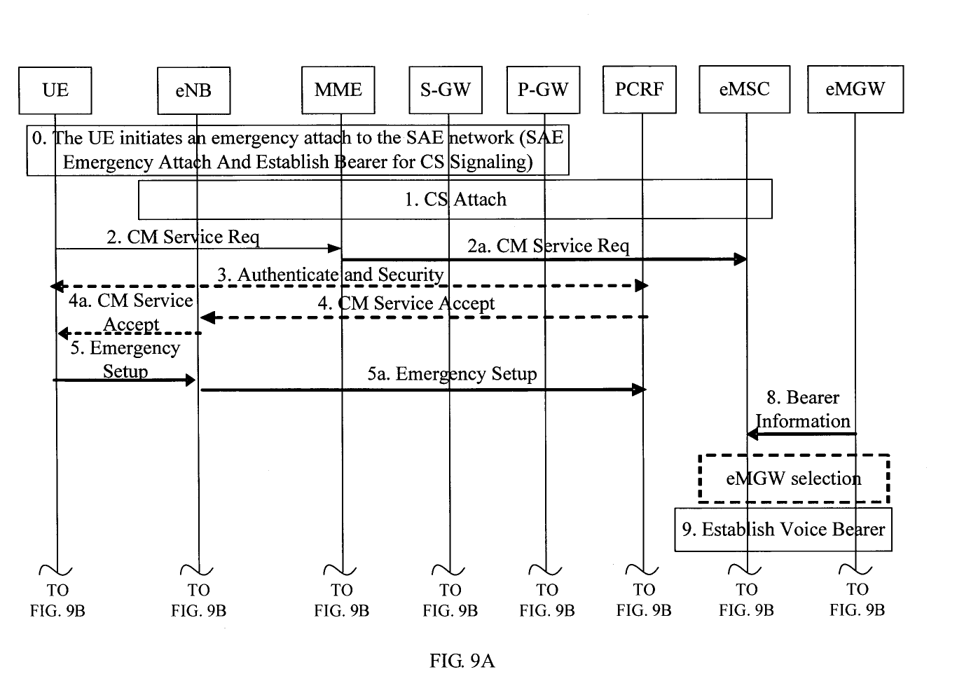

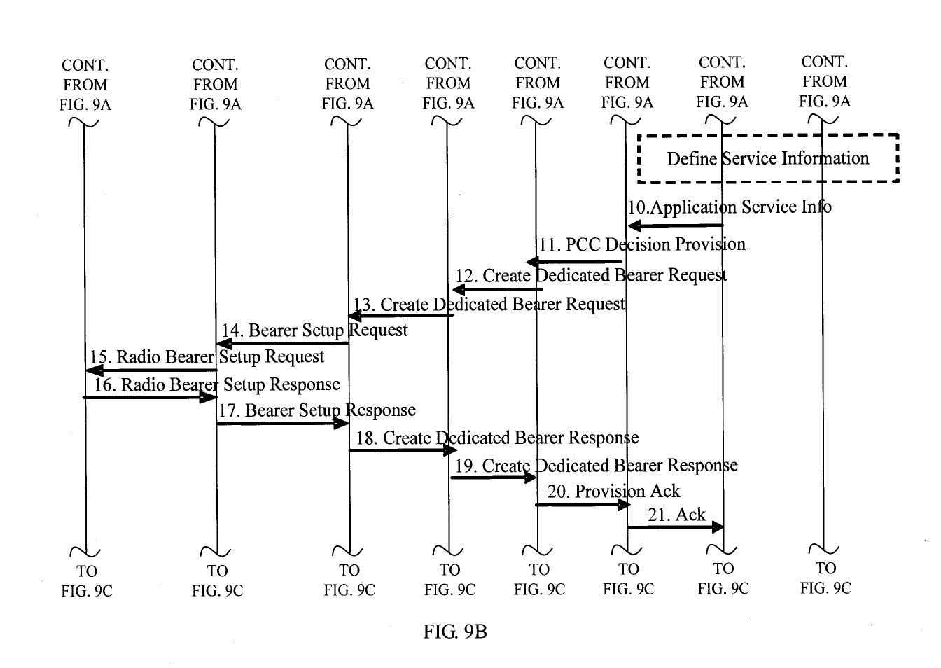

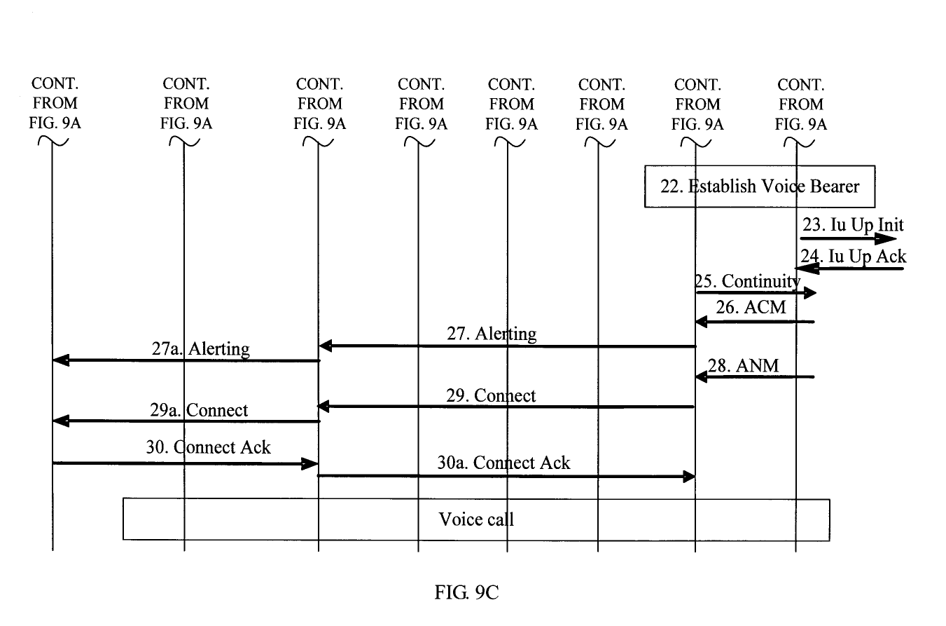

FIG. 9 is a flowchart of a method for simulating the CS domain to implement an emergency call in the PS domain in Embodiment 3 of the present invention. This embodiment is based on architecture B mentioned above, which involves an interface similar to Gs. The blocks of this embodiment are the same as the blocks of Embodiment 2 except that: The signaling sent by the UE to simulate a CS call is encapsulated and transmitted through a NAS signaling in the SAE network. According to the indication carried in the received NAS message, the MME determines that the message needs to be sent to the eMSC, and therefore, the MME transmits the message to the eMSC transparently. Therefore, because a Gs interface exists between the MME and the eMSC, the UE can send the emergency bearer establishment data to the eMSC directly through the MME, without setup of an IP tunnel between the UE and the eMSC as in Embodiment 2.

The UE initiates a simulated CS attach, and transmits attach parameters through an interface similar to Gs and located between the eMSC and the MME.

2. When the UE wants to originate a call, the UE encapsulates the call message into a NAS message in the eUTRAN, and sends the NAS message to the MME. An Data Element (IE) added in this NAS message instructs the MME to send the call message data in the NAS message to the eMSC.

The remaining blocks such as 3-30a are the same as those in Embodiment 2 except that: The signaling message sent by the eMSC to the UE for simulating the CS call is forwarded to the UE through the MME by means of a NAS message.

The dedicated bearer establishment mentioned above is initiated by the eMSC through an Rx interface. Besides, after receiving the Call Proceeding message, the UE may initiate dedicated bearer establishment first, and then the eMSC modifies the dedicated bearer through the Rx interface.

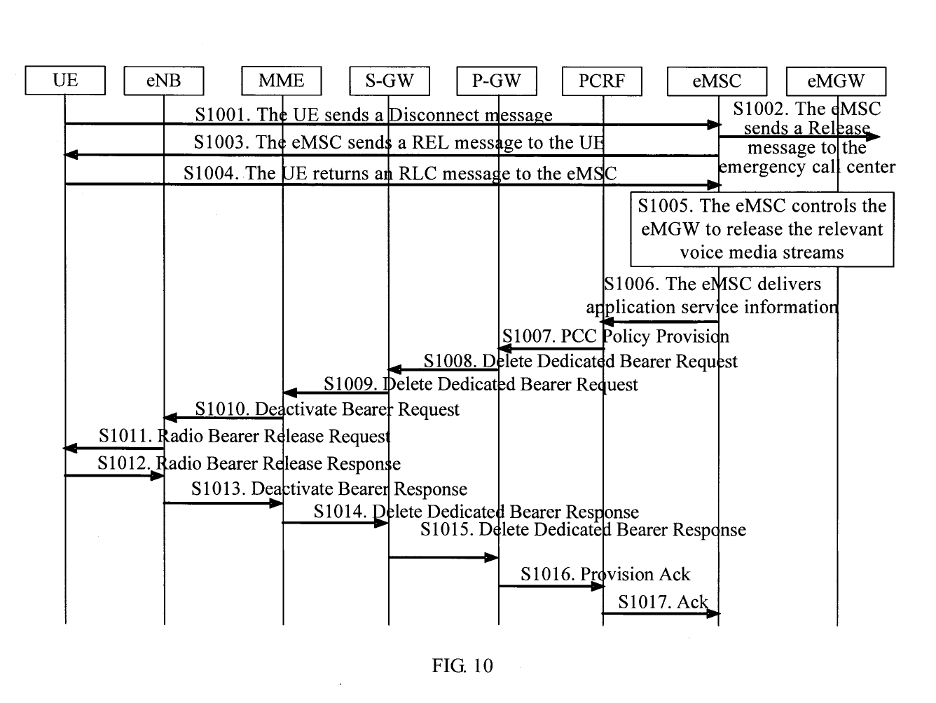

FIG. 10 is a flowchart of a method for simulating the CS domain to implement an emergency call in the PS domain in Embodiment 3 of the present invention. This embodiment is based on architecture A. That is, no interface similar to Gs exists. In this case, an emergency call release process (namely, an emergency call release process initiated by the user) needs to be implemented through IP-layer connectivity.

The relevant release data is a Disconnect message or a Release message.

This embodiment provides a CS emergency call release process initiated by the user (namely, the UE hooks on proactively). By sending a Disconnect message to the eMSC, the UE triggers the process of releasing the dedicated emergency bearer. In this embodiment, a signaling-plane connection is maintained between the UE and the eMSC through the IP connectivity. This embodiment includes the following blocks:

Block S1001: The UE sends a Disconnect message to the eMSC, indicating that the user has hooked on.

Block S1002: The eMSC sends a Release message to the emergency call center located in the PSTN or CS domain.

Block S1003: The eMSC sends a REL message to the UE.

Block S1004: After receiving the REL message, the UE stops all timers related to call control, and then returns an RLC message to the eMSC.

Block S1005: The eMSC controls the eMGW to release the relevant voice media streams.

Block S1006: The eMSC sends application service data to the PCRF to indicate shutdown of the QoS assurance mechanism for the emergency call media streams.

Blocks S1007-S1016: The PDN GW initiates the process of deleting the dedicated emergency bearer of the SAE network.

Block S1017: After the dedicated emergency bearer is deleted, the PCRF returns an Ack message to the eMSC.

The relevant release data is a Disconnect message or a Release message. After block S1009 or block S1013, the MME may recover other dedicated bearers stopped for the emergency call (for example, activate the values of GBR and MBR). That is, when the UE originates an emergency call, some ongoing services may be suspended or stopped for deficiency of resources. In this way, some resources are released to ensure success of the emergency call. Therefore, after the emergency bearer established for the emergency call is released, the suspended or stopped services need to be recovered. The method for suspending/stopping and recovering other dedicated bearers is detailed in the subsequent embodiments of the present invention.

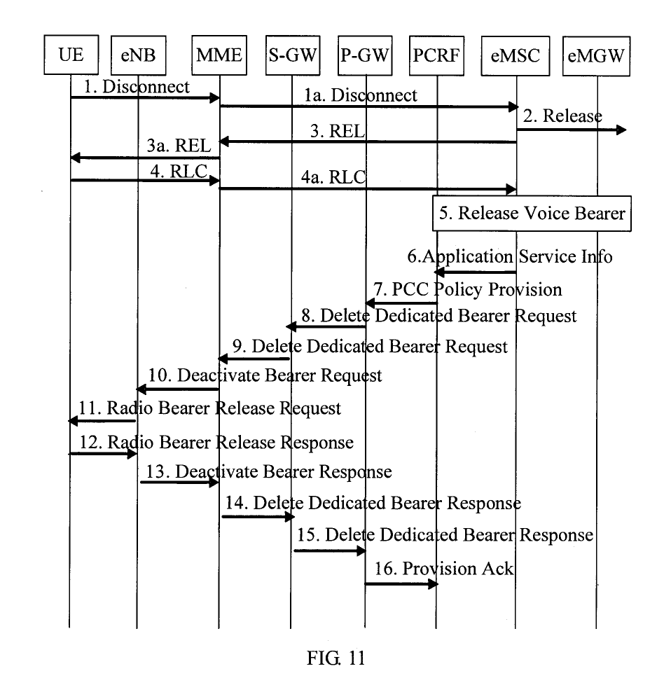

FIG. 11 is a flowchart of a method for simulating the CS domain to implement an emergency call in the PS domain in Embodiment 4 of the present invention. This embodiment is based on architecture B, which involves an interface similar to Gs+. This embodiment sets forth a process of releasing a CS emergency call originated by the UE in the case that the signaling between the UE and the eMSC is transmitted through the NAS plane between the UE and the MME and the signaling plane between the MME and the eMSC.

The blocks of this embodiment are the same as the blocks of Embodiment 3 except that the signaling message for simulating the CS domain between the eMSC and the UE is forwarded by the MME to the UE through the NAS (and transmitted through an interface similar to Gs between the MME and the eMSC). A relevant IE is added to the NAS message to identify whether the message processing is normal NAS message processing in the eUTRAN or signaling message processing of an emergency call. The relevant release data is a Disconnect message or a Release message.

Also, after block S1009 or block S1013 above, the MME may recover other dedicated bearers stopped for the emergency call (for example, activate the values of GBR and MBR).

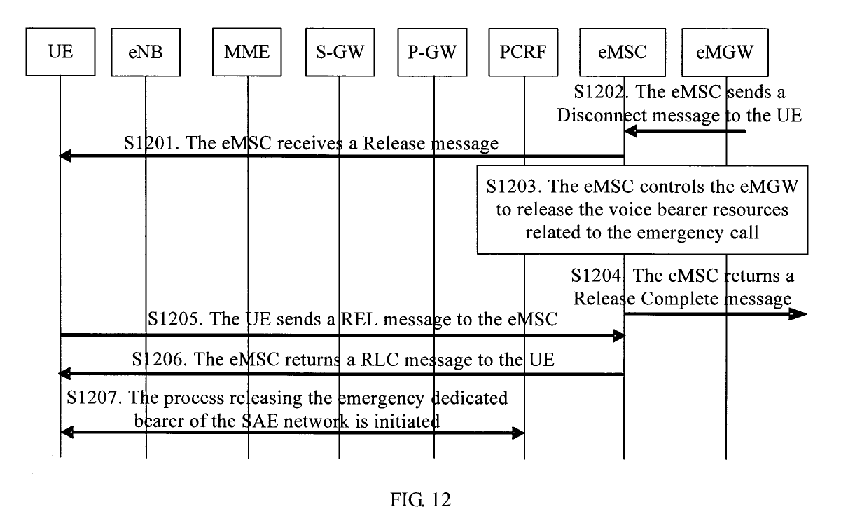

FIG. 12 is a flowchart of a method for simulating the CS domain to implement an emergency call in the PS domain in Embodiment 5 of the present invention. This embodiment is also based on architecture A. That is, no interface similar to Gs exists. In this embodiment, the network initiates the process of releasing the emergency call, which is implemented through IP connectivity. The emergency call release process initiated by the network includes the following blocks:

Block S1201: The eMSC receives a Release message from the emergency call center.

Block S1202: The eMSC sends a Disconnect message to the UE through an IP tunnel, indicating that the far end has hooked on.

Block S1203: The eMSC controls the eMGW to release the voice bearer resources related to the emergency call.

Block S1204: After knowing that the voice bearer resources on the eMGW are released, the eMSC returns a Release Complete message to the emergency call center.

Block S1205: After receiving the Disconnect message, the UE stops the call control timers related to the emergency call, and sends a REL message to the eMSC.

Block S1206: After receiving the REL message and stopping the call control timers, the eMSC returns an RLC message to the UE.

Block S1207: After the UE receives the RLC message, the process of releasing the dedicated emergency bearer of the SAE network is initiated.

The relevant release data is a Disconnect message or a Release message. Also, after Block S1207 above, the MME may recover other dedicated bearers stopped for the emergency call (for example, activate the values of GBR and MBR) after releasing the dedicated emergency bearer.

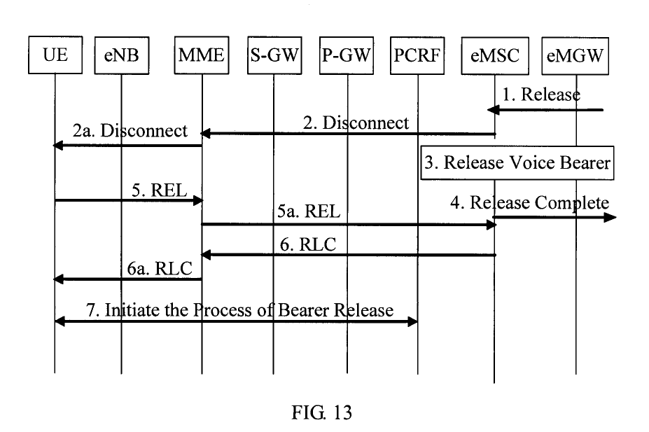

FIG. 13 is a flowchart of a method for simulating the CS domain to implement an emergency call in the PS domain in Embodiment 6 of the present invention. This embodiment is also based on architecture B, which involves an interface similar to Gs+. In this embodiment, the signaling related to the call release is transmitted through a Gs+ interface between an MME and an eMSC. This embodiment deals with the emergency call release process initiated by the network in the case that the call signaling between the UE and the eMSC is forwarded by the NAS plane between the UE and the MME. Meanwhile, after receiving the release message in simulating the CS domain, the UE initiates a process of releasing the dedicated emergency bearer actively. Meanwhile, in this process, the MME can recover other dedicated bearers stopped for the emergency call (for example, activate the values of GBR and MBR). This block is the same as the counterpart of Embodiment 5 except that the message sent by the eMSC to the UE to simulate the CS NAS is forwarded by the MME to the UE. The relevant IE is added to differentiate the normal NAS message processing in the UTRAN. Also, in block 7 above, the MME may initiate the emergency call release process to recover other dedicated bearers stopped for the emergency call (for example, activate the values of GBR and MBR).

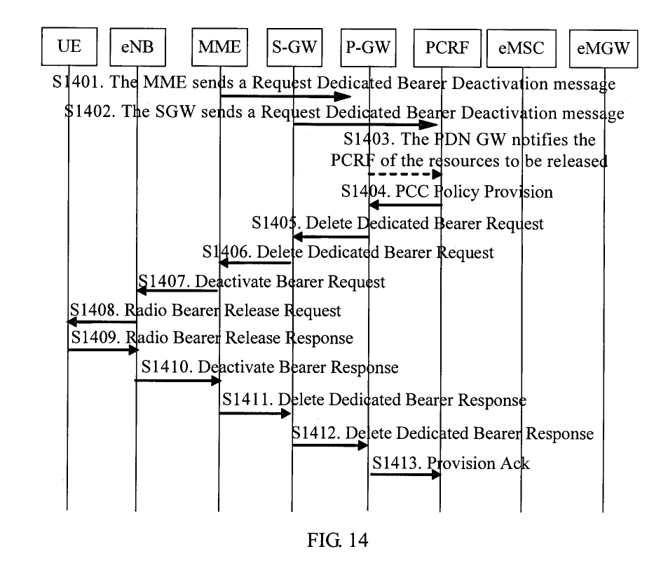

FIG. 14 is a flowchart of a method for simulating the CS domain to implement an emergency call in the PS domain in Embodiment 7 of the present invention. This embodiment deals with a process of deleting or stopping other dedicated bearers while the UE makes an emergency call.

In the case that the UE exchanges service streams with another PDN GW (namely, the PDN GW for the purpose of non-emergency calls) while making an emergency call, to ensure high QoS of the emergency call, the MME performs the process of deactivating or modifying the dedicated bearer (for example, rewrites the GBR and MBR to 0) to delete or stop all other services of the user, or to stop the low-priority services of the user selectively according to the QoS parameters (such as QCI, Label, and ARP) stored in the MME.

In the case of network congestion, when the MME finds that it does not support all requests for establishing dedicated bearers, the MME initiates a process of deactivating or modifying the dedicated bearers to delete or stop the lower-priority services of the emergency call user, thus ensuring success of the emergency call.

Block S1401: The MME sends a Request Dedicated Bearer Deactivation message to the SGW to activate a selected dedicated bearer. A specific parameter or a specific indication bit in the message indicates that the bearer release is caused by an emergency call.

Block S1402: The SGW sends a Request Dedicated Bearer Deactivation message to the PDN GW.

Block S1403: If Policy and Charging Control (PCC) is applied, the PDN GW notifies the PCRF of the resources to be released.

Blocks S1404-S1413: The PDN GW of the SAE network initiates the process of deactivating the dedicated bearer.

When the UE originates an emergency call, the bearer resources on the UE side may be scarce. To ensure high QoS of the emergency call, all other ongoing services may be deleted or stopped (for example, the values of GBR and MBR are rewritten to 0) or the low-priority services are selectively deleted or stopped according to the QoS parameters (such as QCI, label, and ARP) stored in the UE when the UE originates another emergency call. In this way, the resources are released to ensure normal initiation of the emergency call service. In the process of triggering the UE to initiate the release of a dedicated bearer in an SAE system, a specific parameter or a specific indication bit in the release message indicates that the release is caused by an emergency call.

In this embodiment, the eMSC can determine the actual location data of the UE according to the Location Service (LCS). For example, according to the network location data reported by the UE, the eMSC obtains the actual location data of the UE; or, after the UE reports its location data, the reported actual location data may be checked through the LCS so that the emergency call center can accurately locate the UE that makes the emergency call. By locating the UE that makes the emergency call, the embodiment of the present invention can grasp the user location data (such as the cell ID) accurately. In this way, the eMSC can route the emergency call, and allocate the proper resources quickly as required by the user. When processing the emergency call, the eMSC may serve as a client in an LCS architecture. The location data of the UE is received or obtained actively in the following way: If the UE can provide the network location data of the UE (such as the cell ID) in the emergency setup message, or if the eMSC queries the LCS for the user location data through an LCS message in the case that the UE does not provide the network location data in the emergency setup message; or, if the UE provides location data of the UE in the emergency setup message, the eMSC can use the LCS to acknowledge the location data.

A method for simulating a CS emergency call by means of an eMSC entity in the SAE network is provided in an embodiment of the present invention, and therefore, an emergency call service in the SAE/LTE packet network can be implemented independently of the IMS.

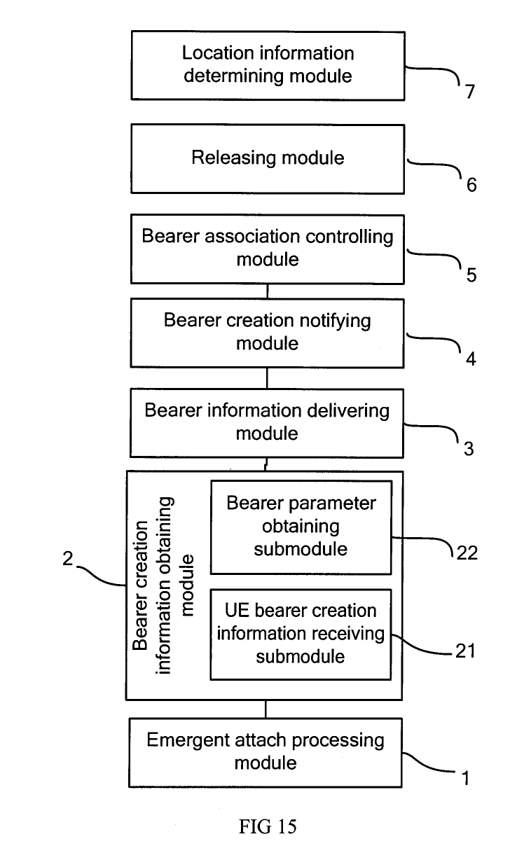

FIG. 15 shows a structure of an emergency call service entity in an embodiment of the present invention. The emergency call service entity is a P-CSCF in the eMSC or IMS. An emergency call service entity includes: an emergency attach processing module 1, configured to receive an Emergency Attach Request from a UE, where the emergency call service entity is a local emergency call service entity selected for the UE by the MME accessed by the UE; a bearer establishment data obtaining module 2, configured to obtain bearer establishment data required for establishing an emergency voice bearer for the UE after the UE originates an emergency call; a bearer data delivering module 3, configured to deliver the bearer establishment data to an eMGW and a PCRF separately; a bearer establishment instructing module 4, configured to instruct the eMGW and the PCRF to establish an emergency voice bearer on the eMGW side and an emergency voice bearer on the SAE network side; and a bearer association controlling module 5, configured to control the eMGW to associate the emergency voice bearer on the eMGW side with the emergency voice bearer on the SAE network side after the bearer on the eMGW side and the bearer on the PCRF side are established, whereupon the UE makes an emergency call according to the emergency voice bearer on the eMGW side and the associated emergency voice bearer on the SAE network side.

The bearer establishment data obtaining module 2 includes: a UE bearer establishment data receiving submodule 21, configured to receive the UE bearer establishment data sent by the UE through an IP tunnel between the emergency call service entity and the UE, or through an interface between the MME and the emergency call service entity; and a bearer parameter obtaining submodule 22, configured to request the relevant bearer parameters from the emergency call center.

The emergency call service entity further includes a releasing module 6, which is configured to release the emergency voice bearer on the eMGW side and the emergency voice bearer on the SAE network side after receiving the release message from the emergency call center or UE.

The emergency call service entity further includes a location data determining module 7, which is configured to determine the specific location of the UE through the LCS according to the location data reported by the UE.

An emergency call service entity is provided in an embodiment of the present invention to simulate the CS emergency call in an SAE network, and therefore, the emergency call service can be implemented in the SAE/LTE packet network.

After reading the foregoing embodiments, those skilled in the art are clearly aware that the present invention may be implemented through hardware, or through software in addition to a necessary universal hardware platform. The technical solution under the present invention may be embodied as a software product. The software product may be stored in a non-volatile storage medium (such as a CD-ROM, a USB flash disk, or a mobile hard disk), and may include several instructions that enable a computer device (such as a personal computer, a server, or a network device) to execute the methods provided in the embodiments of the present invention.

The above descriptions are merely preferred embodiments of the present invention, but not intended to limit the scope of the present invention. Any modification, equivalent replacement, or improvement made without departing from the principle of the present invention should fall within the scope of the present invention.

What is claimed is:

1. An emergency attach method, comprising:
receiving, by a Mobility Management Entity (MME), a Non Access Stratum (NAS) message from a User Equipment (UE), wherein the NAS message carries an emergency indication and a unique ID of the UE;
determining, by the MME, that the UE is originating an emergency call to a System Architecture Evolution (SAE) network according to the emergency indication;
selecting, by the MME, a local Packet Data Network Gateway (PDN GW) for the UE, so that the PDN GW allocates a corresponding Internet Protocol (IP) address to the UE and the UE gets attached to the SAE network.

2. The method of claim 1, further comprising:
selecting, by the MME, the local PDN GW according to the default emergency Access Point Name (APN) data configured by MME.

3. The method of claim 1, further comprising:
obtaining, by the MME, a subscription data of the UE from a Home Subscriber Server (HSS) according to the unique ID of the UE; and,
determining, by the MME, the local PDN GW according to a subscribed emergency APN data in the subscription data, if the subscribed emergency APN belongs to a local network.

4. The method of claim 1, wherein the NAS message carries an emergency APN data;
wherein, the selecting, by the MME, a local PDN GW for the UE, comprises:
determining, by the MME, the local PDN GW according to the emergency APN data, if the emergency APN belongs to a local network.

5. The method of claim 1, the method further comprises:
instructing, by the MME, the SAE network not to perform an authentication and authorization process.

6. The method of claim 1, wherein the NAS message comprises one of a service request message, a Tracking Area Update message, and an attach request message when the UE is originating an emergency call.

7. The method of claim 6, the method further comprises:
if the UE has a Universal Subscriber Identity Model (USIM) card, the unique ID of the UE is an International Mobile Subscriber Identification (IMSI); or,
if the UE has no USIM card, the unique ID of the UE is an International Mobile Equipment Identity.

8. An emergency call method, comprising:
sending, by a User Equipment (UE), an emergency attach request that establishes an emergency indication to a System Architecture Evolution (SAE) network;
selecting, by the SAE network, an emergency call service entity for the UE after receiving the emergency indication;
sending, by the UE, an emergency call request to the emergency call service entity after getting attached to the SAE network emergently; and
establishing, by the emergency call service entity, an emergency voice bearer; and,
initiating, by the UE, an emergency call according to the established emergency voice bearer.

9. The method of claim 8, further comprising:
obtaining, by the emergency call service entity, a bearer establishment data required for establishing the emergency voice bearer for the UE;
delivering, by the emergency call service entity, the bearer establishment data to an evolved Media Gateway (eMGW) and a Policy and Charging Rules Function (PCRF) separately to establish corresponding emergency voice bearers; and
controlling, by the emergency call service entity, the eMGW to associate the emergency voice bearer on the emergency call service entity side with the emergency voice bearer on the SAE network side after the corresponding emergency voice bearers are established.

10. The method of claim 9, further comprising:
sending, by the UE, the bearer establishment data of the UE to the emergency call service entity through an Internet Protocol (IP) tunnel between the emergency call service entity and the UE, or through an interface between a Mobility Management Entity (MME) and the emergency call service entity.

11. The method of claim 9, further comprising:
delivering, by the emergency call service entity, the obtained bearer establishment data to the UE;
requesting, by the UE, the PCRF to establish the emergency voice bearer on the SAE network side according to the received bearer establishment data; and
sending, by the emergency call service entity, the bearer establishment data to the eMGW, and notifying the eMGW to establish the emergency voice bearer on the emergency call service entity side.

12. The method of claim 8, wherein before an evolved Mobile Switching Center (eMSC) receives an emergency attach request from the UE, for a non 3rd Generation Partnership Project (3GPP) network, the method further comprises:
sending the emergency indication to an Authentication, Authorization, and Accounting (AAA) proxy, an AAA server, and a local Packet Data Network Gateway (PDN GW), whereupon the local PDN GW allocates a corresponding Internet Protocol (IP) address to the UE.

13. The method of claim 8, wherein:
the emergency call service entity includes an evolved Mobile Switching Center (eMSC), or a Proxy Call Session Control Function (P-CSCF) in an IP Multimedia Subsystem (IMS).

14. An emergency call service entity, comprising:
an emergency attach processing module, configured to receive an emergency attach request from a User Equipment (UE);
a bearer establishment data obtaining module, configured to obtain bearer establishment data required for establishing an emergency voice bearer for the UE after the UE originates an emergency call;
a bearer data delivering module, configured to deliver the bearer establishment data to a Media Gateway (MGW) and a Policy and Charging Rules Function (PCRF) separately;
a bearer establishment instructing module, configured to instruct the MGW and the PCRF to establish an emergency voice bearer on the emergency call service entity side and an emergency voice bearer on a System Architecture Evolution (SAE) network side; and
a bearer association controlling module, configured to control the MGW to associate the emergency voice bearer on the emergency call service entity side with the emergency voice bearer on the SAE network side after the bearer on the emergency call service entity side and the bearer on the PCRF side are established, whereupon the UE initiates an emergency call according to the emergency voice bearer on the emergency call service entity side and the associated emergency voice bearer on the SAE network side.

15. The emergency call service entity of claim 14, wherein:
the emergency call service entity is one of an evolved Mobile Switching Center (eMSC) and a Proxy Call Session Control Function (P-CSCF) in an IP Multimedia Subsystem (IMS).

16. The emergency call service entity of claim 15, wherein:
the bearer establishment data obtaining module comprises:
a UE bearer establishment data receiving submodule, configured to receive UE bearer establishment data sent by the UE through at least one of an Internet Protocol (IP) tunnel between an evolved Mobile Switching Center (eMSC) and the UE, or through an interface between a Mobility Management Entity (MME) and the eMSC; and
a bearer parameter obtaining submodule, configured to request relevant bearer parameters from an emergency call center.

17. A Mobility Management Entity, comprising:
a receiving unit, configured to receive a Non Access Stratum (NAS) message from a User Equipment (UE), wherein the NAS message carries an emergency indication and a unique ID of the UE;
a determining unit, configured to determine that the UE is originating an emergency call to a System Architecture Evolution (SAE) network according to the emergency indication;
a selecting unit, configured to select a local Packet Data Network Gateway (PDN GW) for the UE, so that the PDN GW allocates a corresponding Internet Protocol (IP) address to the UE and the UE gets attached to the SAE network.

18. The MME of claim 17, wherein the selecting unit further comprises:
a second selecting unit, configured to select the local PDN GW according to the default emergency Access Point Name (APN) configured by MME.

19. The MME of claim 17, wherein the selecting unit further comprises:
an obtaining unit, configured to obtain a subscription data of the UE from a Home Subscriber Server (HSS) according to the unique ID of the UE; and,
a determining unit, configured to determine the local PDN GW according to a subscribed emergency APN data in the subscription data, if the subscribed emergency APN belongs to a local network.

20. The MME of claim 17, the MME further comprises:
an instructing unit, configured to instruct the SAE network not to perform an authentication and authorization process.
